(19) United States
(12) Patent Application Publication
(10) Pub. No.: US 2026/0297927 A1
(43) Pub. Date: Oct. 1, 2026

(54) 3D CONNECTOR FOR MODULAR CONSTRUCTION OF MULTI-STORY BUILDINGS

(71) Applicant: UNIVERSIDADE DE COIMBRA, Coimbra (PT)

(72) Inventors: Luis Alberto PROENCA SIMÕES DE ALMEIDA, Coimbra (PT); David GOMES ANDRADE, Coimbra (PT); Sree SABARI SHUNMUGAM, Coimbra (PT); Jorge CONDE CONDE, Coimbra (PT); Filip LJUBINKOVIC; Ana Francisca HENRIQUES PARENTE DOS SANTOS, Coimbra (PT)

(21) Appl. No.: 19/479,589

(22) PCT Filed: Dec. 14, 2023
(86) PCT No.: PCT/IB2023/062689

§ 371 Date: Oct. 28, 2025

(30) Foreign Application Priority Data
Apr. 28, 2023 (PT) 118621
Jul. 27, 2023 (PT) 118834

(51) Int. Cl. E04B 1/348; E04B 1/24; F16B 7/18

(52) U.S. Cl. CPC E04B 1/3483; F16B 7/185; E04B 2001/2406; E04B 2001/2451

(57) ABSTRACT

The present invention refers to a connection system for the modular construction of multi-story steel buildings, that provides a single connection system that allows for the coupling of pre-made 3D cuboid modules, enabling efficient and cost-effective construction. The connection system is designed to withstand vertical and horizontal loads, ensuring the structural integrity and stability of the building, allowing for remote inter-module connectivity, optimising the usable space within the building, eliminating the need for direct access during construction, which is suitable for connecting eight modules at two-storey levels. The system is easily disassembled, allowing for reconfiguration or disassembly of the building. It also provides levels of horizontal and vertical tolerance, accommodating imperfections that may arise during fabrication and assembly processes. This is achieved through the fitting of connectors (4) inside joining blocks (3) which in turn fit into the inner part of the hollow section column (C).

### TECHNICAL FIELD

The present invention relates to the field of fabricated building structure construction technology, more particularly to a connection system for modular construction of multi-story buildings.

### SCOPE OF THE INVENTION

The present invention refers to a connection system for the modular construction of multi-story buildings. The invention provides a unique connection system that allows the coupling of prefabricated 3D cuboid modules, enabling the efficient and cost-effective construction of multi-story buildings. In addition, the connection system is designed to withstand vertical and horizontal loads, ensuring the structural integrity and stability of the building. The connection system of the present invention also allows remote connectivity between modules, eliminating the need for direct access during construction, which is suitable for connecting eight modules at two-storey levels, significantly reducing construction time. In addition, the system is easily disassembled, allowing the building to be reconfigured or disassembly if necessary. Another advantage of the present invention is the optimisation of usable space within the building. This is achieved through a unique design that maximises the connectivity of the modules, minimising the spaces between them.

### BACKGROUND OF THE INVENTION

Modular construction is a contemporary approach to constructing structures by stacking pre-made modules to create one or more storeys. Modular construction is becoming increasingly popular due to its advantages, such as reducing construction time, lower costs, the ability to reuse components, generate less waste, and recyclability.

Typically, a module includes rectangular frames on the outer edge that connect to the walls and floors. These frames give the module its structural stability and allow its connection to the adjacent stacked modules. Conventional inter-module connections typically involve welded plates and bolts installed from the outside, often requiring adequate bolting or welding space. Perimeter connections can be easily made from the outside of the building, eliminating the need for additional working space or construction gaps.

The patent number CN106460384 refers to a connecting system that primarily consists of main modules at the frame level, frame connecting box and steel rod anchors. The system is only suitable for frame-level construction, which requires expensive logistics and a huge workforce during the on-site construction process for the building of walls, floors, electrical units, and water units. Unlike this invention, the current invention permits to build of walls, floors and other associated units at the factory level, reducing the costs associated with the on-site construction.

The patent application CN115822094A refers to an invention for modular construction that includes a module frame and a connecting structure. This comprises a first mounting piece, a second mounting piece, an intermediate piece, and a structure that is resistant to shear forces. The first mounting piece is designed for connecting to a first structure, while the second mounting piece is designed for connecting to a second structure. These two mounting pieces are connected together through a connecting piece. This design may introduce high-stress concentration at the shearing region since the groove size is more than 50% of the frame depth. To overcome the issue, the current inventions have limited and small grooves that overcome the problems of the stress concentration present in the existing system.

The utility model CN206233372U refers to a prestressed connection and positioning device for steel modular construction so that the modular building can be rigidly fixed without the use of welding and bolts. The main disadvantage of the system is the absence of a provision for disassembly.

Moreover, application number CN115787834A designed an energy-dissipating and shock-absorbing structure for modular self-resetting steel frame that enables the structure to deform and recover after an earthquake. Similarly, application number CN115748981A refers to a modular building, which is detachably arranged on the foundation of the building. Limit ropes are connected to the fastening elements to hold the modules at tension. Due to poor rigidity, the above two connecting system is not suitable for high-rise buildings.

Application number WO2022241263A2 refers to a locking system for building construction that includes a locking body and locking extension that engages with other locking assemblies on modular building units for secure attachment and stable connection between units. Furthermore, application number WO2019057147A1 refers to a connection device and a building module device to enable quick, precise stacking and connection of building modules at project. The patent KR101278983B1 describes a modular unit and a modular structure designed to simplify the assembly and disassembly of joint module structures for the purpose of moving and constructing modules. Also, application number CN104328839A presents a connecting structure for column-bearing integrated building modules that includes a steel tube internal butt connector and a shear-resistant connector with horizontal connecting steel plates and vertical pull rods. Finally, application number WO2015164975A1 refers to a connector system with an upper connector coupled to a lower connector and a gusset plate sandwiched between them.

Nevertheless, the above-mentioned applications may need direct access to the connection sites. In addition, none of the previous inventions refers to whether they can operate with high levels of horizontal and vertical tolerances required for correctly assembling modules during the building construction.

### Advantages of the Invention

Most modular construction approach follows a basic layout where inter-module connections are primarily concentrated along the perimeter. Nevertheless, connecting the modules in the central region, where four units come together, becomes challenging without sufficient working space or a designated opening. These connections are installed sequentially as each module is placed, but there is no access to the fourth module. This problem is even more pronounced when the modular build is made of 3D modules has walls, floors and ceilings, severely restricting the working area. To address this, the modular construction process requires improved on-site assembly methods.

The current connector of the invention solves this problem since it allows connecting the fourth module without direct access. This unique solution comprises several advantages, such as vertical and horizontal load transfer, no need for direct access, accommodating large horizontal and vertical tolerances, ease to assemble and the possibility of being disassembled.

The system of the present invention allows the connection of 3D modules, vertically and horizontally, independently of their location in the modular building. In addition, the system may be assembled easily. The connection system was also designed to be easily demountable, allowing for the disassembly and reconfiguration of modules and minimising non-usable space. Another advantage is that the developed system admits high levels of horizontal and vertical tolerance, seamlessly accommodating imperfections that may arise during both fabrication and assembly processes, among others.

For the related technologies mentioned above, for instance, for the invention referred on the documents CN115822094A, CN206233372U, WO2019057147A1, WO2022241263A2, KR101278983B1, CN104328839A and WO2015164975A1 do not solve the problem since it needs direct access to assemble the building components.

### BRIEF DESCRIPTION OF THE DRAWINGS

These and other features are to be easily understood by the accompanying drawings, which should be taken as examples only and are not to be considered as limiting the scope of the present invention. For illustrative purposes, the measurements of the elements in the drawings may be exaggerated and not drawn to scale. The absolute and relative dimensions do not match actual relations for carrying out the invention.

In a preferred embodiment of the invention:

FIG. 1 shows an exploded view of the connection system between four 3D modules at the same storey level with one 3D module at the next storey level.

FIG. 2 shows an exploded detail view of the connection system between four 3D modules at the same storey level with one 3D module at the next storey level.

FIG. 3 shows the geometry of the bottom part of the 3D module columns.

FIG. 4 shows the support plate assembled in the 3D module column.

FIG. 5 shows the blocking plate assembled in the 3D module column.

FIG. 6 shows the geometry of the joining block.

FIG. 7 shows the cut view of the assembling between the support plate, joining block and the 3D module column.

FIG. 8 shows the connector geometry.

FIG. 9 shows the adjustment of the horizontal washer nuts to the inner walls of the joining block.

FIG. 10 shows a cut view of the vertical locking system between the vertical washer nuts with the blocking plate.

FIG. 11 shows the geometry of the lock part.

FIG. 12 shows the configuration of the single, dual, triple and tetra connection.

FIG. 13 shows examples of assembly configurations of 3D modules through the proposed connection method.

FIG. 14 shows vertical locking between the vertical washer nut with the blocking plate, using a key.

FIG. 15 shows the wedge geometry.

FIG. 16 shows the wedge mechanism to fill the horizontal gap between the joining block and the 3D module column.

FIG. 17 shows the levelling sheets geometry.

FIG. 18 shows an alternative geometry of the connector with long vertical bolts.

FIG. 19 shows the assembling system for the long vertical bolts.

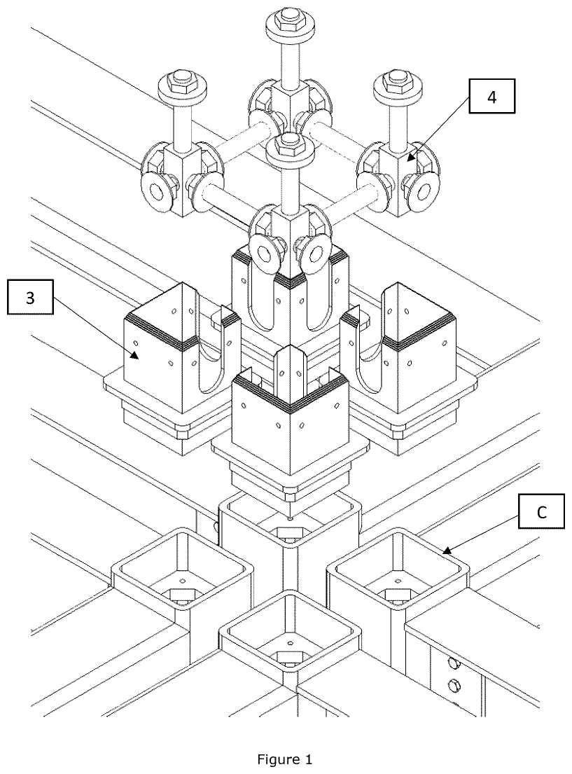

In the drawings are marked the elements and components of the equipment of the present invention, as well as the elements and components necessary for the proper functioning of the invention:
1. support plate
   1.1. hollow centre
   1.2. threaded holes
2. blocking plate
   2.1. hollow centre
   2.2. holes
3. joining block
   3.1. hollow section
   3.2 grooves
   3.3. base holes
   3.4 vertical holes
   3.5. base
   3.6. step
   3.7. ladder wedge
   3.8 lower step
4. connector
   4.1. central piece
   4.2. horizontal rods
   4.3. vertical rods
   4.4. horizontal washer nuts
   4.5. vertical washer nuts
   4.6. long vertical rods
   4.7. gap
5. lock part
   5.1. slotted hole
   5.2 horizontal filler
   5.3. vertical backstop
6. wedge
   6.1. grooved slot
   6.2. ladder wedge
   6.3. fixation mean
   6.4. shaft
   6.5. spring
7. levelling sheets
C. column
   C.1. threaded holes
   C.2. slotted holes
K. key
   K.1. levers
   K.2. bottom part

### DETAILED DESCRIPTION OF THE INVENTION

The term “substantially” is understood to mean that the description of the shape or position of an element of the present invention is not mathematically or geometrically exact, but that the shape or position of an element of the present invention is recognized by an expert in the field as having generically or approximately the described shape or position.

The wording “3D module”, or simply “module”, refers to a hexahedral modular unit made up of four vertical columns on the four vertical edges, referred to as module column (C), four horizontal beams at the edges of the lower level of the aforementioned columns, and four horizontal beams on the edges of the upper level of the columns. These 12 members form the edges of the hexahedral unit, and they are rigidly joined by conventional means namely, but not exclusively, welding or bolting. These basic units are intended to be stacked and joined to form larger sets. During the assembly process of these sets, the faces of each unit may be filled with constructive elements namely, but not exclusively, slabs, walls, and ceilings, thus limiting access to the internal joints between units.

As can be clear to a person skilled in the art, the application of the principles described herein is not limited to the embodiments shown. Possible changes that can occur in the present invention, defined in number, remain within the scope of the present invention.

Additionally, although some embodiments present multiple new features, and as can be seen throughout this document, all features can be independent, and it is not essential that all be used in a single embodiment.

Additionally, the embodiments described herein are merely examples of the effect intended with the present invention, so other ways known from the state of the art to achieve the same technical effect are equally applicable for other embodiments.

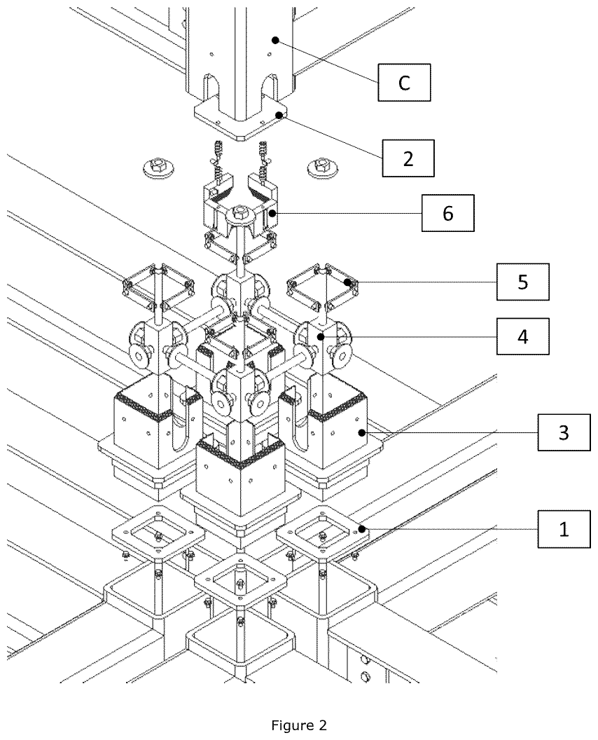

According to FIG. 2, the present invention refers to a 3D connector for modular construction of multi-story buildings, consisting of several main parts: the support plate (1), the blocking plate (2), the joining block (3), the connector (4), the lock part (5) and the wedge (6). FIG. 2 also shows the column (C), component necessary for the invention to work.

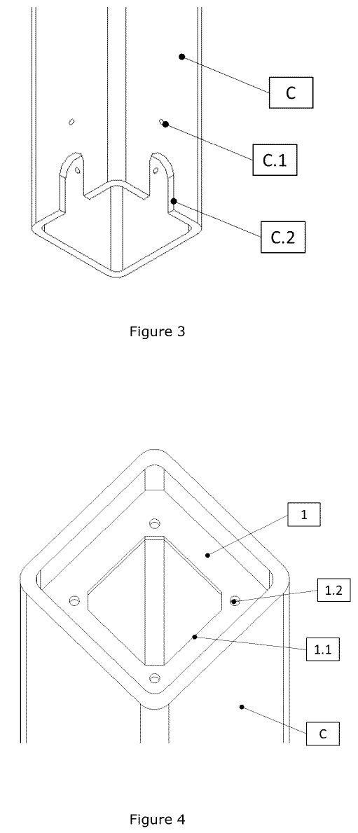

According to FIG. 3, the module columns are made of hollow section members. In the bottom part, the column (C) has threaded holes (C.1) along its four sides and has also grooved machined slotted holes at two adjacent surfaces (C.2).

According to FIG. 4, the support plate (1) is a plate with chamfered corners, which has a shape substantially complementary to the shape of the inner part of the hollow section column (C), to which it is attached, and placed at a slightly recessed position with respect to the top surface of the column (C). The support plate (1) has a substantially parallelepiped hollow centre (1.1) and threaded holes (1.2) along its perimeter.

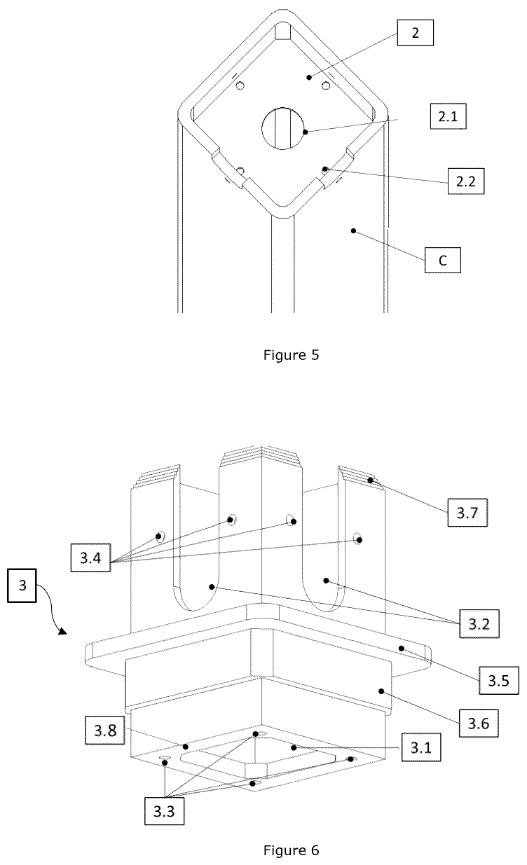

According to FIG. 5, the blocking plate (2) is a square plate with chamfered corners, which has a shape substantially complementary to the shape of the inner part of the hollow section column (C), to which it is attached, and placed at a slightly recessed position with respect to the bottom surface of the column (C). The blocking plate (2) has a substantially circular hollow centre (2.1) of the blocking plate (2) and substantially circular holes (2.2) along its perimeter.

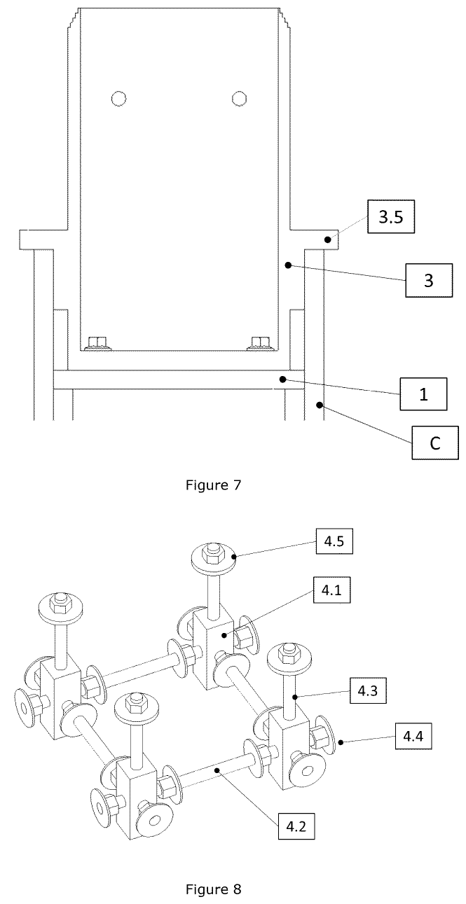

According to FIG. 6, the joining block (3) comprises a hollow section (3.1), at least one, preferably two adjacent, machined slotted grooves (3.2), vertical holes (3.4) on all its lateral surfaces, a base plate (3.5) at mid-height comprising at least one inverted step (3.6), which at the base of the lower step (3.8) incorporates base holes (3.3), and a ladder wedge (3.7) in all top surface. In one embodiment, the joining block (3) is assembled along the substantially vertical direction inside the 3D module column (C) until it reaches contact with the support plate (1). The joining block (3) is held in position by fixing elements through the base holes (3.3) in its base, which are aligned with the threaded holes (1.2) of the support plate (1). The fixing elements of the joining bloc (3) are, namely, but not exclusively, bolts, ensuring that it is easily disassembled. The referred joining block (3) is especially suited for 3D cuboid modules where the columns (C) are made up of hollow sections. As shown in FIG. 7, after assembling the joining block (3) in the column, the base plate (3.5) should be in contact with the top surface of the column (C). The base plate (3.5) must be wide enough to accommodate the top module column (C) easily. The top step (3.6) of the joining block (3) should allow a tight fit between the joining block (3) with the inner walls of column (C), allowing the transmission of horizontal loads. However, the versatility of the connection system allows the joining block (3) to be adapted to other types of 3D cuboid modules, with or without hollow sections. For instance, it can be fixed in different locations, or it can be welded instead of being fixed with fixing elements. The hollow section (3.1) and the grooves (3.2) allow the vertical assembling of the connector (4).

According to FIG. 8, the connector (4) comprises a central piece (4.1) which is connected to horizontal rods (4.2) and to vertical rods (4.3). The connection between the central piece (4.1) and the horizontal rods (4.2) and vertical rods (4.3) may be performed, namely, but not exclusively, by welding or through threaded holes in the central piece (4.1). The horizontal rods (4.2) and vertical rods (4.3) are fastened by horizontal washer nuts (4.4) and vertical washer nuts (4.5) are also a part of the connector system. To facilitate the assembling of the connector (4), the slotted grooves (3.2) of the joining block (3) must be wider than the diameter of the horizontal rods (4.2) to adjust for possible misalignments between the 3D modules.

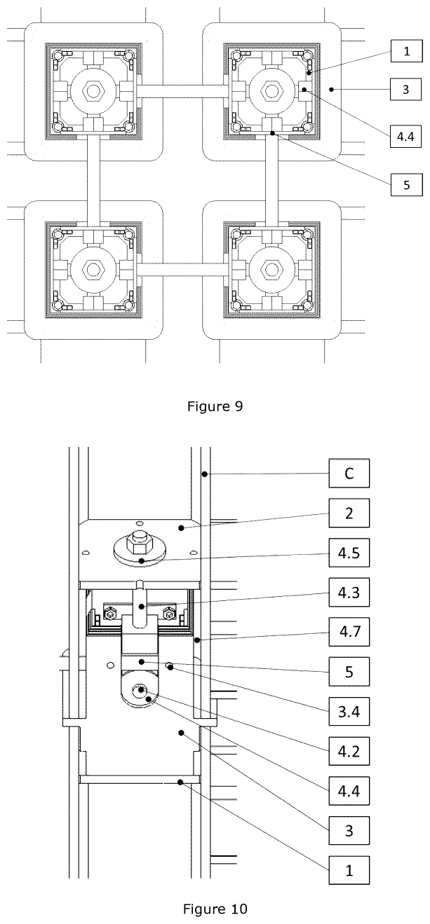

The connector (4) allows vertical and horizontal interlocking and load transfer between the 3D modules. As shown in FIG. 9, to enable horizontal load transfer between modules, the horizontal washer nuts (4.4) should be fastened against the inner wall of the joining block (3). As shown in the cut view of FIG. 10, the vertical washer nuts (4.5) should be fastened against the top surface of the blocking plate (2) to enable vertical load transfer between stacked modules. The rods (4.2, 4.3) and the washer nuts (4.4, 4.5) allow a significant adjustment level in their horizontal and vertical position. Also, the diameter of the hollow centre (2.1) of the blocking plate (2) should be greater than the diameter of the vertical rods (4.3) to accommodate any horizontal deviation between the stacked 3D modules.

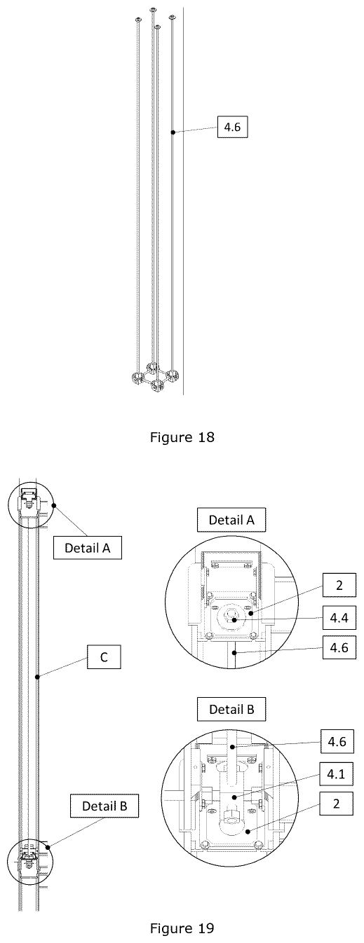

FIG. 18 shows another embodiment of the connector (4), with long vertical bolts (4.6), instead of regular vertical rods (4.3), reaching the top surface of the 3D module. Although this configuration requires more material, its main advantage is that it does not require a long key (K) to fasten the vertical washer nuts (4.5). For the alternative configuration of the connector (4) with long vertical bolts (4.6), it is not necessary to use the support plate (1). Instead, simply use the blocking plate (2) placed at a slightly recessed position in relation to the column top surface of the column (C), as shown in FIG. 19. This figure also shows that the long vertical bolts (4.6) go from the joining block (3) to the top part of the 3D module that was vertically stacked. All the remaining components, this is the plate (2), the joining block (3), the connector (4), the lock part (5) and the wedge (6) are also used for the long vertical bolts (4.6) configuration.

As shown in the cut view of FIG. 10, in order to increase the vertical load capacity of the connector (4), a lock part (5) fixed by means of fastening elements in the vertical holes (3.4) of the joining block (3), prevents the vertical movement of the horizontal washer nuts (4.4) through physical contact.

According to FIG. 11, the lock part (5) has a substantially parallelepiped, preferably, substantially rectangular, shape, with two slotted holes (5.1) to allow its assembling in the vertical holes (3.4) of the joining block (3). The shape of the slotted holes (5.1) allows for some vertical adjustment when placing the lock part (5). The lock part (5) also has a horizontal filler (5.2), which may have different thicknesses, to accommodate the horizontal gap between the horizontal washer nuts (4.4) and the inner wall of the joining block (3). This configuration allows to accommodate large horizontal tolerances for the 3D modules during the assembly. If no horizontal tolerance is needed, the thicknesses of the horizontal filler (5.2) may be null.

When vertical tension loads are applied in the connector (4), the connector (4) remains in position due to the frictional forces applied on the walls of the joining block (3) through the horizontal washer nuts (4.4). To enhance the vertical load capacity of the connector (4), a vertical backstop (5.3) is used to constrain the vertical movement of the horizontal washer nuts (4.4) through physical contact. For this purpose, the vertical backstop (5.3) must always be thicker than the horizontal filler (5.2). This solution allows a significant level of adjustment on the vertical tolerances due to the vertical rods (4.3) and the threaded vertical washer nuts (4.5). Also, vertical backstop (5.3) allows the possibility of applying pretension on the vertical rods (4.3).

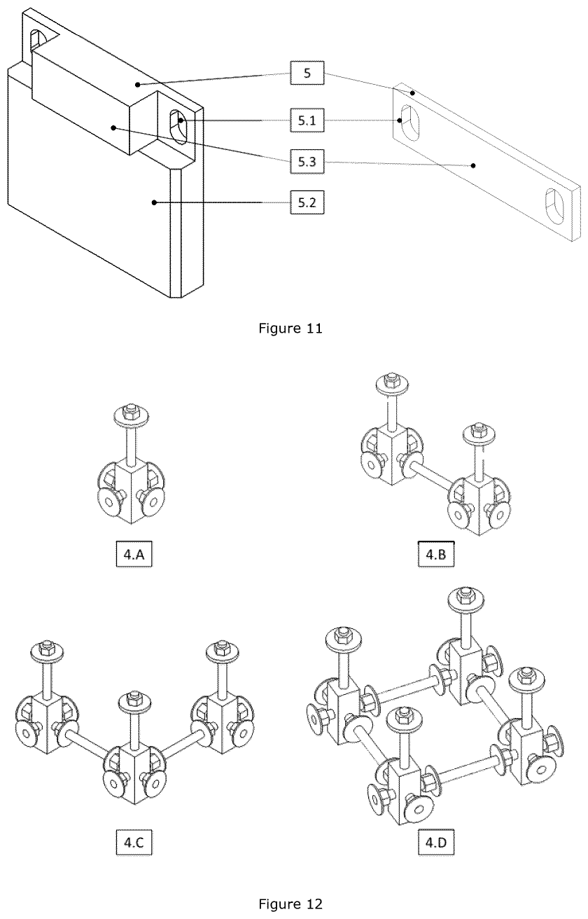

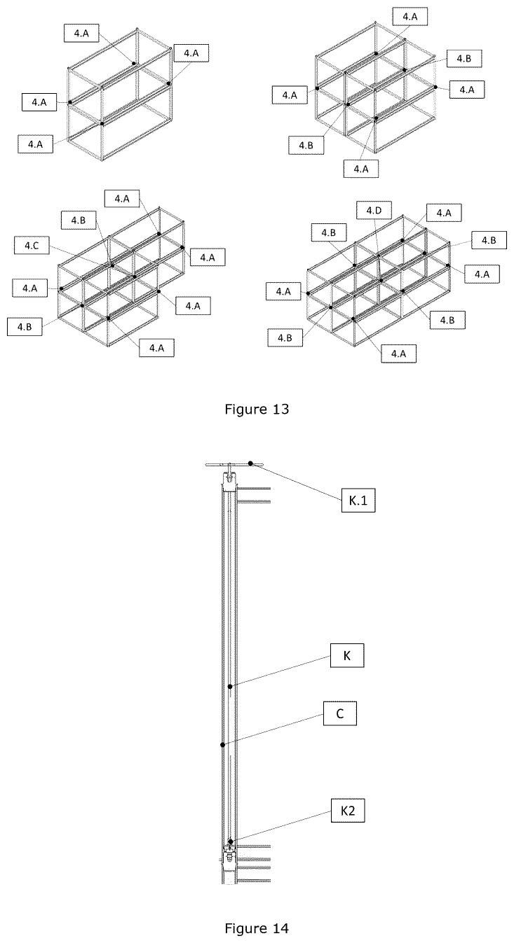

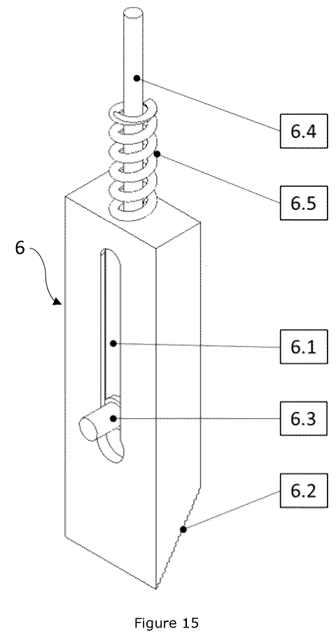

As shown in FIG. 12, the connectors (4) were designed to be used in a single configuration (4.A), dual configuration (4.B), triple configuration (4.C) or tetra configuration (4.D), which allow the connection of one, two, three or four 3D modules at the same storey height, before starting stacking the next 3D modules on the top floors. The single (4.A), dual (4.B), triple (4.C) and tetra (4.D) configurations allow the construction of several types of modular construction buildings, such as two, four, six and eight modules at two storey levels, for example, as shown in FIG. 13.

When the top 3D module is put in place, the vertical locking is only effective after the vertical washer nuts (4.5) are tightened. This is only possible after the top 3D module is in place. To position and tighten the vertical washer nuts (4.5), according to FIG. 14, a specialized key (K) is used, which is accessible through the top region of the hollow column (C) of the top module is required. The key (K) at the top part may be made up of several levers (K.1) that facilitate the rotation of the vertical washer nuts (4.5). In turn, in its lower part (K.2), it is made by a magnetic member to hold the vertical washer nuts (4.5) in place and by a lighting and endoscopic camera system to help guide the special key (K) while descending the column (C) until it reaches the vertical rods (4.3) and tighten the nut.

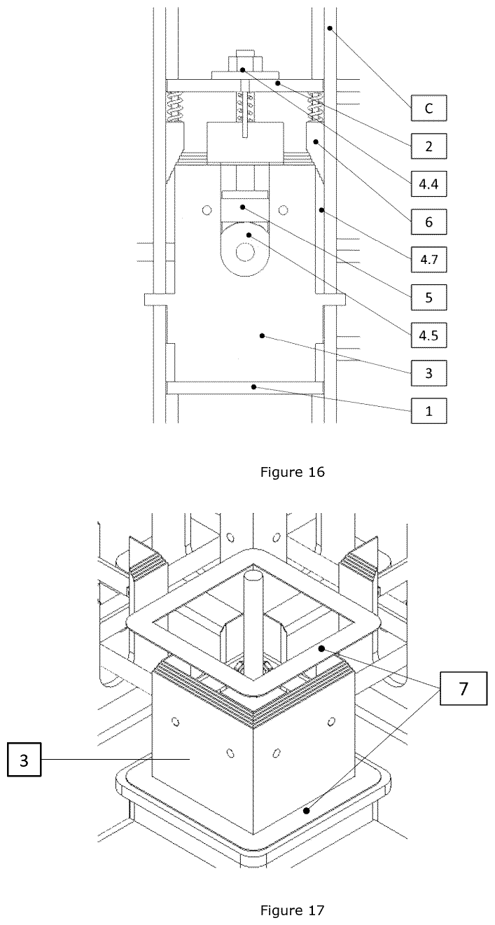

As can be seen in FIG. 10, the width of the joining block (3) is less than the width of the column (C), and there is a horizontal gap (4.7) between the components. This gap is of significant importance as it allows for high tolerances during the assembly of the 3D modules, accommodating imperfections that may arise during the manufacturing and assembly processes, among others. However, in order to block the horizontal movement of the upper and lower 3D modules and transmit the horizontal loads between them, a wedge (6) part must be placed between the outer wall of the joining block (3) and the inner wall of the column (C) of the upper module. The wedge (6) is flat on one side with a grooved slot (6.1), while the opposite side has a ladder wedge (6.2) configuration. This wedge (6) system is pre-installed at the bottom part of the column (C), in the slotted holes (C.2) through a fixation mean (6.3). The fixation mean (6.3) is designed to allow a free vertical movement of the wedge (6) system, along the length of the grooved slot (6.1), at the same time, no horizontal movement is allowed due to physical constrain of the grooved slot (6.1) that holds the head of the fixation mean (6.3). As shown in FIG. 16, these fixation means (6.3) are at the bottom of the columns (C). During the placement of the upper 3D module, this wedge (6) system will move vertically to fill the gap (4.7) between the bottom part of the column (C) with the joining block (3). The ladder wedge (6.2) will be in contact with the ladder wedge (3.7) of the joining block (3). At the top part of the wedge (6) is a hole that accommodates a shaft (6.4) where a compression spring (6.5) is installed. The compression spring (6.5) will help the wedge (6) to be kept in position, even under a high level of horizontal loading. For the wedge (6) to move freely in the vertical direction, avoiding the contact between the shaft (6.4) and the blocking plate (2), the shaft (6.4) must be concentric with the circular holes (2.2) of the blocking plate (2).

In another embodiment, levelling between 3D modules at the same storey level is possible through the levelling sheets (7). These levelling sheets (7) have a square hollow shape that fits the surface of the joining block (3). Placing several levelling sheets (7) on top of each other allows the 3D modules to be levelled at the same storey level before stacking 3D modules of the upper floor.

The construction sequence of the 3D modular building should be as follows: The column (C) of the 3D modules must have already pre-installed the support plate (1), the blocking plate (2) and the wedge (6) system; placing the four, three, two or one 3D modules on the same level as the floor; placing the joining block (3); placing the connector (4) and adjusting the horizontal washer nuts (4.4); placing the lock part (5); levelling with the levelling sheets (7), if necessary; placement of the upper 3D module; threading the horizontal washer nuts (4.5) with the key (K); repeat the process to assemble the subsequent storey levels until the construction of the building is completed.

1. A 3D connector for modular construction of multi-story steel buildings comprising:
a joining bloc (3) assembled along the substantially vertical direction inside a 3D module column (C), comprising a hollow section and grooves;
a connector suitable for vertical and horizontal interlocking and load transfer between 3D modules;
wherein the hollow section and the grooves are suitable for the assembling of the connector in the joining bloc.

2. The 3D connector according to claim 1, wherein the 3D connector further comprises a support plate, a blocking plate a lock part (5) and a wedge (6).

3. The 3D connector according to claim 1, wherein the joining block comprises a hollow section, at least one machined slotted grooves, vertical holes on all its lateral surfaces, a base plate at mid-height comprising at least one inverted step, which at the base of the lower step incorporates base holes, and a ladder wedge in all top surface.

4. The 3D connector according to claim 1, wherein the joining block is held in position by fixing elements through base holes in its base, which are aligned with threaded holes of the support plate

5. The 3D connector according to claim 1, wherein the connector comprises a central piece which is connected to horizontal rods and to vertical rods, which are fastened by horizontal washer nuts and vertical washer nuts.

6. The 3D connector according to claim 1, wherein the diameter of the slotted grooves of the joining block are wider than the diameter of the horizontal rods.

7. The 3D connector according to claim 1, wherein the horizontal washer nuts are fastened against the inner wall of the joining block suitable for horizontal load transfer between modules.

8. 3D connector according to claim 1, wherein the vertical washer nuts are fastened against the top surface of the blocking plate through the threaded shafts suitable for vertical load transfer between modules.

9. The 3D connector according to claim 1, wherein the diameter of a hollow center of the blocking plate is greater than the diameter of the vertical rods.

10. The 3D connector according to claim 1, wherein the lock part has a substantially parallelepiped shape with slotted holes, fixed by means of fastening elements in the vertical holes, suitable for preventing the vertical movement of the horizontal washer nuts through physical contact.

11. The 3D connector according to claim 1, wherein the lock part further comprises a horizontal filler, with different thicknesses, suitable for accommodating the horizontal gap between the horizontal washer nuts and the inner wall of the joining block.

12. The 3D connector according to claim 1, wherein the lock part further comprises a vertical backstop thicker than the horizontal filler, suitable for constraining the vertical movement of the horizontal washer nuts and for allowing the possibility of applying pretension on the vertical rods.

13. The 3D connector according to claim 1, wherein the top part of the wedge is a hole suitable for accommodating a shaft where a compression spring is installed, keeping the wedge in position.

14. The 3D connector according to claim 1, wherein the 3D connector further comprises levelling sheets with a square hollow shape fitting the surface of the joining block levelling modules at the same story level.

15. The 3D connector according to claim 1, wherein the support plate, the blocking plate the joining block, the connector, the lock part the wedge are made of steel.
